(19) United States
(12) Patent Application Publication
(10) Pub. No.: US 2018/0243887 A1
(43) Pub. Date: Aug. 30, 2018

(54) Tool System with Power Wrench and External Operating Part

(71) Applicants: Jörg Hohmann, Meschede (DE); Frank Hohmann, Warstein (DE)

(72) Inventors: Jörg Hohmann, Meschede (DE); Frank Hohmann, Warstein (DE)

(21) Appl. No.: 15/757,346

(22) PCT Filed: Sep. 12, 2016
(86) PCT No.: PCT/DE2016/100424

§ 371 Date: Mar. 3, 2018

(30) Foreign Application Priority Data
Sep. 14, 2015 (DE) 10 2015 115 469.2

(51) Int. Cl. B25B 21/00; B25B 23/147; B25F 5/02

(52) U.S. Cl. CPC B25B 21/002; B25B 23/1456; B25F 5/02; B25B 23/147

(57) ABSTRACT

The invention relates to a tool system for carrying out an electronically controlled tightening of a high-strength screw connection using a power wrench. In addition to the power wrench there is provided an external operating part, having an input unit for inputting configuration data and a display (main display) for visually displaying to the user information and/or measurement values relating to the torque curve during screwing. To enable a user tightening a screw to obtain feedback about the torque curve during screwing or about an ongoing tightening, independently of the main display of the external operating part, an auxiliary display is provided on the power wrench in addition to the main display provided on the external operating part.

The invention relates to a tool system for carrying out an electronically controlled tightening process of a high-strength screw connection or for carrying out a series of such tightening processes, comprising
a hand-guided, external-power-operated power wrench having an external-power-operated drive unit and an electronic power wrench control device for controlling the tightening process according to predefined configuration data which characterizes the screwing operation, and
a hand-held, external operator control part which is independent of the power wrench and has an input unit for inputting at least the configuration data and has a display for visually representing the configuration data and/or other information and/or measured values, relating to the screwing operation or a tightening process, to the user,
wherein the power wrench and the operator control part can communicate with one another via a data connection.

Tool systems for tightening high-strength screw connections with a power wrench (tightening torques in ranges from approximately 150 Nm to approximately 15,000 Nm) and an external operator control part which communicates with the power wrench via a wireless or cable-bound data connection are known from laid-open patent application EP 0 946 336 A1 which originates from the instant applicant.

Power wrenches which do not have an external operator control part assigned to them have, in comparison with systems with an external operator control part, the disadvantage that all the configuration data for the respective screwing operation which relates to a screwing operation and is included in the control process has to be input at the power wrench. For this purpose, an electronic input unit with operator control keys and display has to be provided at the power wrench itself, but in practice this has proven disadvantageous. In particular in difficult working positions or in the case of adverse external conditions, safe and reliable inputting by a user often involves a large effort. Furthermore, the fact that an input unit which is arranged on the power wrench structurally does not permit any input keys and no display of a size which could ensure sufficient user-friendliness contributes to this. Furthermore, the to a certain extent sensitive electronics and mechanics of such an input unit cannot cope sufficiently with the high stresses on the power wrench during daily use.

An input unit which is provided at the power wrench itself can therefore be relocated into an external operator control part which is independent of the power wrench and has input keys and a display, which operator control unit can be held and operated more easily as a hand-held operator control part than the generally heavy and cumbersome power wrench. As a result, the power wrench is freed of the input electronics which are in some cases sensitive and delicate to operate. Any inputs for programming or configuring the power wrench are made via the input unit of the external operator control part, which provides greater freedom for use-friendly dimensioning of input keys and the display. Data is transmitted to the power wrench in a wireless fashion or via a cable connection.

However, such a solution has proven disadvantageous in that as a result of the relocation of the display to an external operator control part, in many cases in which the user cannot position the external operator control part in his field of vision he loses visual feedback from the information displayed on the display about the current screwing operation to be carried out. In particular, during a specific tightening process during which the user requires both hands for operating and holding the power wrench, there is no possibility of viewing the display provided on the external operator control part in order to visually check any process data of the tightening process or to monitor compliance with certain specifications of a series of tightening processes of a screwing operation. In addition, even when the user manages to position the external operator control part with the display within his field of vision, he will generally inevitably have to avert his gaze from the power wrench, at least temporarily. It is also to be borne in mind that, in particular, a continuous wireless transmission of data is susceptible to errors and is frequently interrupted, which can lead to a situation in which documentation processes about screwing operations are incorrect, or are even not documented at all, and the monitoring of a tightening process is possible only with gaps.

Against this background, the object of the invention is to provide a tool system comprising a power wrench and an external operator control part which is assigned thereto and with which, despite the possibility of configuring the power wrench by means of an input unit, provided at the external operator control part, for a specific screwing operation, the user retains the possibility, during a screw tightening process or during the execution of a series of tightening processes, of visually checking and monitoring information about the tightening process, the configuration of the power wrench or compliance with certain specifications, independently of the display at the external operator control part.

According to the invention this object is achieved in that, in addition to the display which is provided at the external operator control part, an auxiliary display is provided at the power wrench, which auxiliary display can display to the user information relating to the screwing operation or a specific tightening process, independently of the display of the external operator control part.

As a result the user can receive, even if to a more limited extent than via the main display at the external operator control part, feedback about the configuration of the power wrench or about the processes relating to the current screwing operation, without having to rely on the external operator control part. Nevertheless, because of the external operator control part he retains the possibility of configuring the power wrench in a comfortable way.

The tool system is preferably configured here in such a way that all the configuration data is implemented exclusively at the external operator control part, and more preferably an input facility for inputting configuration data is not provided at the power wrench. A control device for controlling the tightening process, and therefore the “intelligence” of the system which is necessary for a tightening process is located exclusively in the power wrench. Such distribution of the operator control and the functions between the two devices of the power wrench and the operator control part which are independent of one another ensures, on the one hand, comfortable and safe inputting of the configuration data via the external operator control part and ensures that the power wrench is kept free of delicate input electronics and input mechanics and, on the other hand, ensures autonomous use of the power wrench, independent of the existence of the data connection, during the processing of a screwing operation by the user.

The information which can be displayed at the auxiliary display can be, in particular, configuration data which has been input at the external operator control part and transmitted to the power wrench by means of the data connection, this being, for example, configuration data relating to the target torque, the target angle or the tightening sequence in a screwing operation which comprises a series of tightening processes. The information which can be displayed at the auxiliary display can also be information which can be derived directly from such configuration data.

It is therefore possible to confirm the power wrench configuration visually to the user or to guide him through a relatively complex screwing operation with assistance by means of a display on the auxiliary display and by the power wrench control process, without the user having to repeatedly have recourse to the external operator control part. However, in addition to such configuration data, it is also possible to display on the auxiliary display any error messages or information on the basis of which the user can read off the progress within an individual tightening process, e.g. a progress bar, or within a series of successive tightening processes, e.g. a number of the screw connection which is to be currently tightened and/or the number of the screw connection which is to be tightened next. If the user is supported in this way by the system, the risk of an error is minimized.

A digital memory unit is preferably provided at the power wrench, in which memory unit the configuration data which is used to control the power wrench is stored, and the content of which configuration data can be read out by means of the external operator control part, changed at the external operator control part and written back into the digital memory unit at the power wrench.

There can be provision that if the wireless or cable-bound data connection between the power wrench and the external operator control part is active, simultaneous data (current measured values, log data, fault messages, data on the current device status) can be transmitted during a tightening process from the power wrench to the external operator control part, and, in particular, current measured values, status data and fault messages can also be displayed there via the main display. In order also to be able to use the power wrench autonomously and independently of the existence of a data connection from the external operator control part for logging, there is, however, preferably provision that, in particular, the log data which is necessary for satisfactory logging of a screwing operation is firstly stored in a memory unit which is provided at the power wrench, and a data connection between the power wrench and the external operator control part is not established, and the data is not read out by means of the external operator control part via the data connection, until after the conclusion of the screwing operation.

The external operator control part is preferably configured in such a way that it can be connected to a computer via a wireless data connection or in a wire-bound fashion via suitable interfaces, in order, for example, to be able to be supplied with configuration data, in particular of relatively complex screwing operations, by means of the computer. Log data which is stored in the operator control part can also be read out by means of such a data connection, or the logging architecture which is stored in the operator control part can be adapted in the computer. This ensures that relatively complex inputs and programming operations which can only be carried out with difficulty because of the size and limited operator control capability of the operator control part which is preferably kept to a small and handy size, by means of said operator control part, can be carried out in a comfortable way on a computer.

In order to provide the user with further assistance, in addition to the auxiliary display one or more visual displays on the basis of which the user is informed, for example, about the current communication status, the programming status or the process status, can be provided at the power wrench. Such visual displays can be formed, for example, by LED lamps, the continuous or intermittent lighting up of which and/or the color of which can permit the user to draw conclusions about current states of the tool system.

The power wrench and the external operator control part are preferably both battery-operated. In order to charge the battery, the tool system comprises a battery charging device at which, in addition to a battery of the power wrench, the external operator control part can also be charged.

In one preferred embodiment, the external operator control part is a smartphone or a tablet computer which can connect to the power wrench in a wireless fashion or by means of a cable and on which an application is programmed, with the result that the data provision processes and reading out processes can, as described above, be carried out by means of the smartphone or the tablet computer. In this context, it is to be noted that any input keys which are provided on the input unit of the external operator control part can of course also be part of a touch-sensitive screen.

The data connection between the power wrench and the external operator control part is preferably configured as a wireless data connection. The power wrench and the external operator control part have, for this purpose, transmitter and receiver devices which permit such a wireless data connection. Nevertheless, it is, of course, also possible to implement the data connection between the power wrench and the external operator control part in a cable-bound fashion. In this case, interfaces for establishing a cable-bound data connection between the power wrench and the external operator control part are provided at the power wrench and the external operator control part.

Below there is a description of a further aspect of an external-power-operated and hand-held power wrench which can be used in combination with the invention described above, in particular that is to say in combination with a tool system which comprises an external operator control part and a power wrench, or else can also be used separately from the latter, that is to stay in particular even without an external operator control part.

The external-power-operated power wrench has, like the power wrench described above, for carrying out an electronically controlled tightening process of a high-strength screw connection or for carrying out a series of such tightening processes, in addition to an external-force-operated drive unit, also an electronic power wrench control device for controlling the tightening process according to predefined configuration data which characterizes the screwing operation.

After a tightening process has been completed, it may be the case that because of the high torques which are to be applied (approximately 150 Nm to 15,000 Nm in battery powered wrenches) the power wrench tilts after a screw tightening process owing to high torsional stresses at the assembly which has the screw connection. The user can then, under certain circumstances, no longer remove the power wrench from the assembly again, or can only do so with extreme effort, with the result that the user generally sets a reversal of the direction of rotation which is provided at the power wrench, and subsequently activates the power wrench so as to rotate briefly in the release direction of the screw connection, in order to correct again a tilting of the power wrench which has occurred at the assembly. This process of free rotation can be time-consuming and laborious, in particular if a large number of screw tightening processes have to be carried out in succession, and before each free rotation the user must firstly actually detect that the power wrench is actually tilted by virtue of the fact that he cannot remove the power wrench from the assembly, then set the reversal of the direction of the rotation, carry out the free rotation process and subsequently set the reversal of the direction of rotation again for the subsequent screw tightening process, in order to cancel out the previous reversal of direction of rotation again.

There can therefore advantageously be provision that the electronic power wrench control device of the power wrench comprises a free rotation control process which in an automated fashion initiates, subsequent to the execution of a screw tightening process (rotation of the screw or nut in the tightening direction) a free rotation process which can comprise, in particular, one or more successive brief activations of the power wrench in the release direction (the direction opposed to the tightening direction) or else a rapid succession of operations of reversal of the direction of rotation, as a result of which the power wrench is moved in the release direction and back again in quick succession and very small angular movements. The free rotation process preferably does not cause the screw or nut to turn back in the release direction but instead can already be ended when it is detected, by means of the electronic power wrench control device and/or by means of a process of detecting free rotation which can be provided separately from the power wrench control device or else as a component of the power wrench control device, that the power wrench is not or is no longer tilted.

A power wrench with such a free rotation control process or with such a free rotation detection process is considered to be an independent invention which can be claimed separately from the provision of an external operator control part. Nevertheless, such a free rotation control process or free rotation detection process can also be part of the described tool system. In the latter case, the request to an electronically controlled screw tightening process that after the conclusion of the actual screw tightening process a free rotation process is to be initiated can form part of the configuration data which characterizes the screwing operation and can be transmitted to the power wrench by means of the external operator control part via the data connection. However, there can also be provision that the decision as to whether an automated free rotation process is to be carried out subsequent to a tightening process by the power wrench control process can be left solely to the user. For this purpose, it is possible to provide on the power wrench a selection switch whose activation causes an automated free rotation process to be carried out subsequent to a screw tightening process. The latter is, of course, possible irrespective of whether the power wrench is a part of a tool system which comprises an external operator control part.

The following description of the drawings serves to describe preferred embodiments of the invention.

In the drawings:

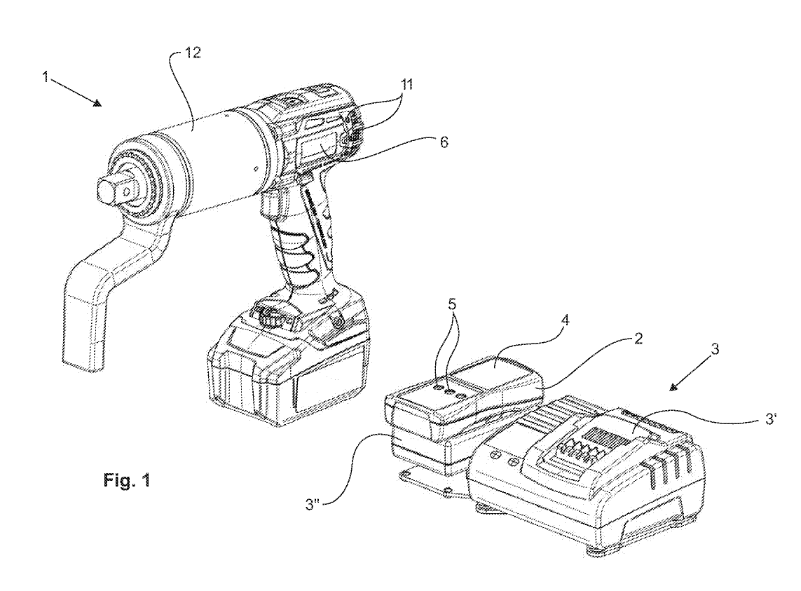

FIG. 1 shows a tool system with a battery-operated power wrench, an external operator control part which is independent of the power wrench, and a battery charging device,

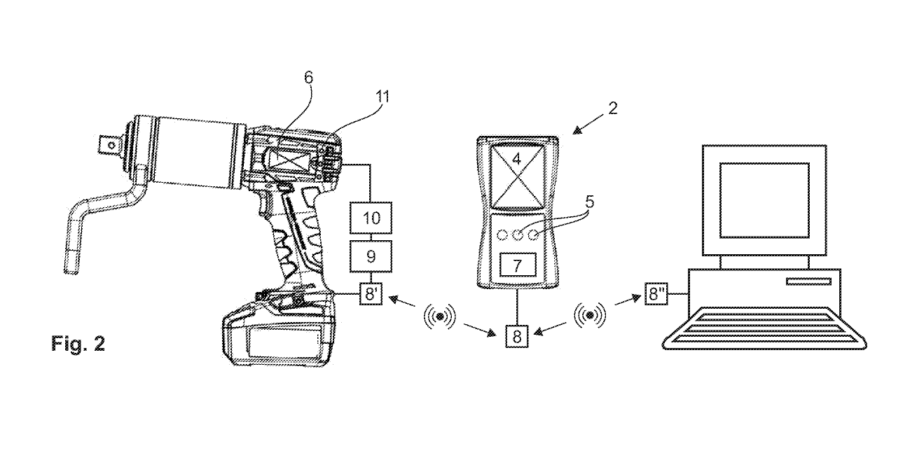

FIG. 2 shows a schematic illustration of a wireless data communication taking place between the external operator control part and the power wrench as well as between the external operator control part and a computer,

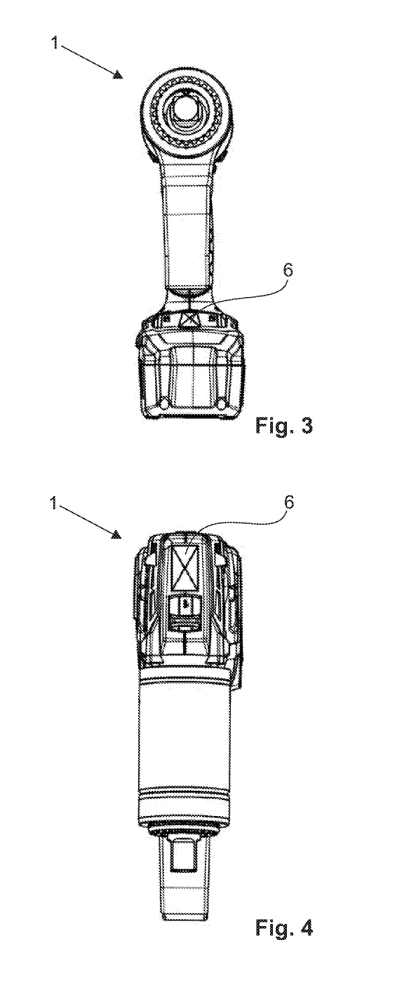

FIG. 3 shows a first alternative refinement of the power wrench shown in FIG. 1, and

FIG. 4 shows a second alternative refinement of the power wrench illustrated in FIG. 1.

FIG. 1 shows a tool system for establishing a high-strength screw connection to a battery-operated power wrench 1, an external operator control part 2 which is independent of the power wrench 1, and battery charging device 3. The battery charging device has a receptacle 3′ for a battery which is intended to operate the power wrench, and a coupling device 3″ for connecting the external operator control part 2 to the battery charging device 3 for a charging process of the battery of the external operator control part 2.

A main display 4 and input keys 5 are provided on the external operator control part 2, said input keys 5 being intended, in particular, for the inputting of configuration data relating to a screwing operation into the operator control part 2 or for the execution of any commands such as, for example, the initiation of a transmission of configuration data to the power wrench 1 as well as for menu control.

An auxiliary display 6, by means of which, in particular, configuration data which has been input into the external operator control part 2 before a tightening process to be carried out or a series of tightening processes to be carried out, and has been written into a memory unit of the power wrench via the wireless data connection (in contrast to what is shown in the figures, a cable-bound data connection can also be used), or information which is derived from such information can be displayed, is provided on the power wrench 1.

FIG. 2 illustrates schematically the processes taking place during the exchange of data, using an illustration of components which are involved in the exchange of data between the power wrench 1 and the external operator control part 2.

Configuration data for a screwing operation which is to be executed and which is written into an operator control memory unit 7 which is present in the operator control part 2 is input by the user by means of the input keys 5 on the external operator control part 2. By means of a transmitter and receiver unit 8 which is provided on the operator control part 2, the configuration data is transmitted via a wireless data connection to a transmitter and receiver unit 8′ which is provided on the power wrench 1, and stored in said transmitter and receiver unit 8′ in a power wrench memory unit 9. An electronic control device 10 can call this configuration data and calculate therefrom, together with other stored data, the control data and control rules which are required for the configured screwing operation.

The display of, in particular, the configuration data on the auxiliary display 6 which is arranged on the power wrench permits the users to provide visual feedback about the supplying of the power wrench with data and/or the correct execution of a tightening process or a series of tightening processes without the user having to rely on the display of the external operator control part.

In addition to configuration data such as target torque, target angle, screw size and quality of material, information about the process status or fault messages which happen to occur can be displayed on the main display 4 of the external operator control part 2. In addition to such information, device settings of the operator control part itself as well as those of the assigned power wrench can, of course, also be displayed and, if appropriate, are variable by means of inputs. A documentation system in which data of a screwing operation which is written by the power wrench into its memory and has been read out via the operator control part can be stored is also stored in the operator control part.

It is also possible to provide that instantaneous measured values detected in the power wrench, such as the current torque, screwing angle, motor current, rotation speed, temperatures, battery voltage or battery capacity or G sensor values during an ongoing tightening process and insofar as as a data connection has been set up between the power wrench and the external operator control part, can be continuously transmitted by the power wrench and received by the operator control part and displayed.

Further feedback, such as, for example, the fact that a data transmission is currently taking place or that the system is ready for use and that no fault messages are present, can also be provided to the user via a further visual display device, in the form of a plurality of LEDs, which is provided on the power wrench.

FIG. 2 also shows, in addition to the possibility of a wireless connection of the operator control part 2 and power wrench 1, the possibility that the operator control part 2 can be connected, via a data connection which can be wire-bound or wireless, to a computer via a further transmitter and receiver device 8″ which is provided thereon, in order to be able to carry out the configuration of the operator control part 2 or of applications stored there, such as for example those of a documentation system, via an external computer. The external operator control part 2 can be read out via the computer, with the result that the obtained data to be able to feed also to relatively complex further processing or evaluation, such as the operator control part which has been kept compact and handy would not permit.

FIG. 3 and FIG. 4 show that the auxiliary display 6 does not necessarily have to be arranged on the side and above a handle on the power wrench, as shown in FIG. 1 and FIG. 2, but rather that the structural positioning of the auxiliary display 6 can be carried out relatively freely. While the auxiliary display 6 in FIG. 3 is provided underneath the handle on an upwardly pointing surface of a widened portion of the handle which receives the battery, the auxiliary display 6 is arranged pointing upward above the handle in the embodiment illustrated in FIG. 4.

In the figures, the external-force-operated power wrench is displayed as a power wrench which is operated electrically by means of a battery. Of course, the force which is necessary to establish the high-strength screw connection can also be applied by other types of “external forces” (force which is not applied manually by the user) insofar as said force can be controlled by means of an electronic power wrench control device for controlling the tightening process according to predefined configuration data which characterizes the screwing operation. In particular an electronically controlled hydraulic system is possible here.

### LIST OF REFERENCE NUMBERS

1 Power wrench
2 External operator control part
3 Battery charging device
3′ Receptacle for the power wrench battery
3″ Receptacle for the external operator control part
4 Main display
5 Input keys
6 Auxiliary display
7 Operator control part memory unit
8 Transmitter and receiver unit on the operator control part
8′ Transmitter and receiver unit on the power wrench
8″ Transmitter and receiver unit on a computer
9 Power wrench memory unit
10 Electronic control device
11 LED
12 Drive unit

What is claimed is:

1-13. (canceled)

14. A tool system for carrying out an electronically controlled tightening process of a high-strength screw connection or for carrying out a series of such tightening processes, the tool system comprising:
a hand-guided, battery-operated power wrench (1) comprising a drive unit (12) and further comprising an electronic power wrench control device (10) configured to control a tightening process according to predefined configuration data characterizing the screwing operation;
a hand-held, battery-operated operator control part (2) which is independent of the power wrench (1) and comprises an input unit (5) configured to input at least the predefined configuration data and further comprises a first display (4) configured to visually display the predefined configuration data or other information and/or measured values, relating to the screwing operation or the tightening process;
a battery charging device configured to charge a battery of the power wrench (1) and to charge a battery of the external operator control part (2);
the power wrench (1) comprising an auxiliary second display (6) configured to display information relating to a screwing operation or a specific tightening process, independently of the first display (4);
the power wrench (1) and the external operator control part (2) configured to communicate with one another via a data connection;
the tool system configured such that the predefined configuration data is implemented exclusively at the external operator control part (2);
the tool system comprising a free rotation control process.

15. The tool system as claimed in claim 14, wherein exclusively the power wrench control device (10) of the power wrench (1) controls and monitors the tightening process.

16. The tool system as claimed in claim 14, wherein the data connection is a wireless data connection, wherein the predefined configuration data input at the external operator control part (2) is transmitted wireless though the wireless data connection to the power wrench (1), wherein the information displayed on the auxiliary second display is the predefined configuration data or data derived from the predefined configuration data.

17. The tool system as claimed in claim 14, wherein the power wrench (1) further comprises a digital memory unit (9) configured to store the predefined configuration data used to control the power wrench (1), wherein the external operator control part (2) is configured to read out a content of the predefined configuration data stored in the digital memory unit, to change the content to a changed content, and to write the changed content back into the digital memory unit (9) at the power wrench (1).

18. The tool system as claimed in claim 14, wherein the power wrench (1) further comprises a digital memory unit (9) configured to store log data relating to the screwing operation being performed, wherein the tool system is configured such that the log data is not read out of the digital memory unit (9) by the external operator control part (2) until after conclusion of the screwing operation.

19. The tool system as claimed in claim 14, wherein the operator control part (2) further comprises an interface configured to connect the external operator control part (2) to a computer.

20. The tool system as claimed in claim 14, wherein the power wrench (1) further comprises one or more visual displays (11) in addition to the auxiliary second display (6).

21. The tool system as claimed in claim 14, wherein the data connection is a wireless data connection comprising transmission and reception devices (8, 8′) provided at the power wrench (1) and at the external operator control part (2).

22. The tool system as claimed in claim 14, wherein the data connection is a cable-bound data connection, wherein the power wrench (1) and the external operator control part (2) comprise interfaces configured to establish the cable-bound data connection.
